(19) United States
(12) Patent Application Publication
(10) Pub. No.: US 2021/0103633 A1
(43) Pub. Date: Apr. 8, 2021

(54) DYNAMIC RESPONSIVE FORM CREATION

(71) Applicant: Microsoft Technology Licensing, LLC, Redmond, WA (US)

(72) Inventors: Christina SARDO, Seattle, WA (US); Miguel A. RESTO, Snoqualmie, WA (US); Pallavi TANEJA, Bellevue, WA (US); Mahin TORKI, Vancouver (CA); Bradley T. HAVERSTEIN, Kirkland, WA (US); Aaron D. WEST, Seattle, WA (US); Alan Israel CASTELLANOS MORENO, Bothell, WA (US); Anand RENGASAMY, Bothell, WA (US); Miguel Eduardo RIVERA SALAZAR, Redmond, WA (US)

(73) Assignee: Microsoft Technology Licensing, LLC, Redmond, WA (US)

(21) Appl. No.: 16/596,148

(22) Filed: Oct. 8, 2019

(51) Int. Cl. G06F 17/24; G06F 17/22

(52) U.S. Cl. CPC G06F 17/243; G06F 17/2282; G06F 17/227

(57) ABSTRACT

In some examples, dynamic responsive form creation may include obtaining, in a live environment and for a form, an indication of a modification to a field of the form. A modification to a schema may be determined in the live environment and based on the indication of the modification to the field of the form. A transformed schema may be generated based on transformation, in the live environment, of the modification to the schema. The transformed schema may be in a format that is usable to modify the form. An input associated with the field may be obtained in the live environment and based on a modified form generated from the transformed schema. A determination may be made, in the live environment, as to whether the input is valid by analyzing a validation associated with the field.

### BACKGROUND

A form may be generated by using a variety of techniques. Once such technique may include dragging and dropping blocks of information into a user interface. Once the blocks of information are dragged and dropped into the user interface, the information may be analyzed to generate a static form. In this regard, it is technically challenging to build a complex form that is not limited to such blocks of information that are available to generate a form. Once a static form is generated, the form may need to be edited. In this regard, the environment in which the static form was generated may be redeployed to modify the static form. In this regard, it is technically challenging to build and edit a complex form in a live environment, without having to redeploy the live environment.

### BRIEF DESCRIPTION OF DRAWINGS

Features of the present disclosure are illustrated by way of example and not limited in the following figure(s), in which like numerals indicate like elements, in which:

FIG. 1 illustrates a layout of a dynamic responsive form creation apparatus in accordance with an embodiment of the present disclosure;

FIGS. 2A-2D illustrate project controls examples to illustrate operation of the dynamic responsive form creation apparatus of FIG. 1 in accordance with an embodiment of the present disclosure;

FIG. 3 illustrates a virtual machines project to illustrate operation of the dynamic responsive form creation apparatus of FIG. 1 in accordance with an embodiment of the present disclosure;

FIG. 4 illustrates a container project to illustrate operation of the dynamic responsive form creation apparatus of FIG. 1 in accordance with an embodiment of the present disclosure;

FIG. 5 illustrates an Azure™ applications project to illustrate operation of the dynamic responsive form creation apparatus of FIG. 1 in accordance with an embodiment of the present disclosure;

FIG. 6 illustrates a project type schema definition to illustrate operation of the dynamic responsive form creation apparatus of FIG. 1 in accordance with an embodiment of the present disclosure;

FIGS. 7A-7F illustrate various steps of a logical flow to illustrate operation of the dynamic responsive form creation apparatus of FIG. 1 in accordance with an embodiment of the present disclosure;

FIG. 8 illustrates an example block diagram for dynamic responsive form creation in accordance with an embodiment of the present disclosure;

FIG. 9 illustrates a flowchart of an example method for dynamic responsive form creation in accordance with an embodiment of the present disclosure; and

FIG. 10 illustrates a further example block diagram for dynamic responsive form creation in accordance with another embodiment of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Dynamic responsive form creation apparatuses, methods for dynamic responsive form creation, and non-transitory computer readable media having stored thereon machine readable instructions to provide dynamic responsive form creation are disclosed herein. The apparatuses, methods, and non-transitory computer readable media disclosed herein provide for the definition and generation of responsive forms. The responsive forms may be used, for example, to collect and validate data for a project. Based on the utilization of the responsive forms, any changes with respect to a project may be readily implemented and displayed at a production level environment. In this regard, the apparatuses, methods, and non-transitory computer readable media disclosed herein provide for the building of dynamic forms on the fly in a live environment, without having to redeploy the environment.

As disclosed herein, a form may be generated, for example, by dragging and dropping blocks of information into a user interface. Once the blocks of information are dragged and dropped into the user interface, the information may be analyzed to generate a static form. In this regard, it is technically challenging to build a complex form that is not limited to such blocks of information that are available to generate a form. Once a static form is generated, the form may need to be edited. In this regard, the environment in which the static form was generated may be redeployed to modify the static form. In this regard, it is technically challenging to build and edit a complex form in a live environment, without having to redeploy the live environment.

Yet further, with respect to dynamic responsive form creation, an example of operation of the apparatuses, methods, and non-transitory computer readable media is disclosed herein with respect to a portal, such as the Microsoft™ Cloud Partner Portal™, that may be utilized to manage how a company's products and services are displayed across different websites. In this regard, the portal may be utilized by a user, such as an Internet service provider (ISP) or a publisher, to define projects. A project may be described as details of products or services of a company. As disclosed herein, the process of defining a project may include implementation of code to define the project, testing of the code, and a multi-day procedure for deployment of the project. If the project is to be modified for reasons such as changes to the project, bug fixes, etc., such a modification may also iclude modification of the code, testing of the modified code, and a further multi-day procedure for deployment of the modified project. For example, with respect to services such as Azure™ compute, Azure™ storage, and other such services, if an update is made to a service, the update may also need to be made to support virtual machines, test applications, or other products that are being offered. In this regard, it is technically challenging to implement a project in an efficient and expedited manner, without implementation of code to define the project, testing of the code, and a multi-day procedure for deployment of the project. It is also technically challenging to implement modifications to an existing project in an efficient and expedited manner, without modification of the code, testing of the modified code, and the further multi-day procedure for deployment of the modified project.

In order to address at least the aforementioned technical challenges, the apparatuses, methods, and non-transitory computer readable media disclosed herein provide for the definition and generation of responsive forms. A form may be described as a list of fields (e.g., text fields, image upload fields, drop-down values, toggle fields, etc.). For example, the fields may define a project type. A form may be defined and generated, for example, via JavaScript Object Notation (JSON), and may include unique styles, workflows, and conditional rules. The apparatuses, methods, and non-transitory computer readable media disclosed herein provide for the definition of fields that may show up in a portal, such as the Microsoft™ Cloud Partner Portal™, where a user, such as a publisher, may input information for their project. The field as disclosed herein may be defined via a JSON file, input, and any changes may be immediately shown downstream, for example, on a production web application. For example, any change that is made to a project type definition, which may be referred to as a JSON definition that defines contents of a form, may be immediately shown to a user, such as a publisher. Moreover, the fields may be saved on-the-fly (e.g., in a live environment), as opposed to the need for a user to wait for a code change, deployment, testing, and rollout. With respect to projects, forms may also be used to display and validate inputs.

According to examples disclosed herein, the apparatuses, methods, and non-transitory computer readable media disclosed herein provide for definition of validations with respect to inputs, for example, on text fields, drop-down fields, image uploads, and other such fields.

According to examples disclosed herein, the apparatuses, methods, and non-transitory computer readable media disclosed herein provide for customization of the behavior of a form, and validation, for example, for each project type.

According to examples disclosed herein, certain operations of the apparatuses, methods, and non-transitory computer readable media disclosed herein may be controlled via a JSON object. The JSON object may be denoted a project type. A project type may include specifications of what the JSON object for the project looks like, the user interface used to collect data for the project, validations that are performed on fields of the project (e.g., both on the client and server side), locking that is performed on properties of the project, and scoping. The project type may also include specifications of locking that is applied to elements that are not to be changed after they have been published. Further, the project type may include specifications of conditions that are used to decide whether a property is needed/visible if another property (or properties) has a specified value.

Project types that share certain types of functionalities may be combined into one project type definition. In this regard, a project type may include another project type as a child by utilizing mixins. Mixins, as disclosed herein, may provide for the sharing of project type definitions amongst multiple different project types, for example, when the same type of data is to be collected. For example, with respect to projects such as virtual machines projects and test application projects as disclosed herein, such projects may share certain fields. In this regard, instead of duplicating code for such shared fields, a reference may be made to each of the project type definition JSONs, and the shared fields may show up in each of the forms in the portal. According to another example, with respect to examples of projects such as virtual machines projects and test application projects as disclosed herein, if the same data is to be collected for a “marketplace” storefront (e.g., an “Azure™ marketplace” storefront), these two projects may include a “marketplace” mixin.

With respect to examples of projects such as virtual machines projects, test application projects, and container projects as disclosed herein, JSON definitions of such projects may include fields, any validations, and/or conditional information. Fields may be described as any entries in a project in which data may be input, or a selection may be made. Validations may be described as any type of check that is performed on an entry with respect to a field to ensure that the entry is compliant with a rule related to the field. Conditional information may be described as information that may be utilized on a form to show or hide certain fields, depending on values of other fields, for example, within the project.

According to examples disclosed herein, the apparatuses, methods, and non-transitory computer readable media disclosed herein provide for the building and editing of dynamic and complex forms on-the-fly (e.g., in a live environment). In this regard, a user, such as an administrator for a portal, may declare how the user would prefer to collect data for a project, which may make the project GET/PUT application programming interfaces (APIs) include customizable behaviors (e.g., different validations, different object shapes, etc.) for different types of projects.

According to examples disclosed herein, the apparatuses, methods, and non-transitory computer readable media disclosed herein provide for the expedited conversion of new project type definitions to live projects. In this regard, development time with respect to a new project may be minimized. Similarly, modification of projects may be minimized with respect to bug fixes, and other such anomalies.

According to examples disclosed herein, the apparatuses, methods, and non-transitory computer readable media disclosed herein provide for the generation of fully usable forms based on a single configuration file (e.g., a project type definition JSON). In this regard, the apparatuses, methods, and non-transitory computer readable media disclosed herein provide for the elimination of code deployment. For example, an updated form may be shown in a portal by first proceeding to a project type definition page, inputting the JSON, and saving the input.

For the apparatuses, methods, and non-transitory computer readable media disclosed herein, modules, as described herein, may be any combination of hardware and programming to implement the functionalities of the respective modules. In some examples described herein, the combinations of hardware and programming may be implemented in a number of different ways. For example, the programming for the modules may be processor executable instructions stored on a non-transitory machine-readable storage medium and the hardware for the modules may include a processing resource to execute those instructions. In these examples, a computing device implementing such modules may include the machine-readable storage medium storing the instructions and the processing resource to execute the instructions, or the machine-readable storage medium may be separately stored and accessible by the computing device and the processing resource. In some examples, some modules may be implemented in circuitry.

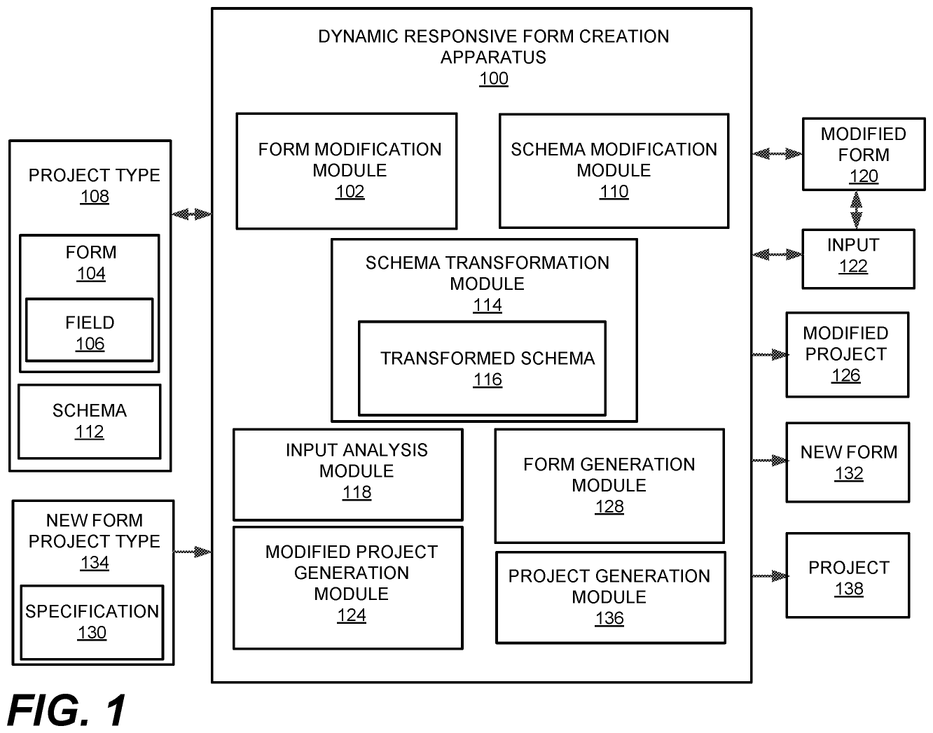

FIG. 1 illustrates a layout of an example dynamic responsive form creation apparatus (hereinafter also referred to as “apparatus 100”).

Referring to FIG. 1, the apparatus 100 may include a form modification module 102 to obtain, in a live environment and for a form 104, an indication of a modification to a field 106 of the form 104. According to examples disclosed herein, the form 104 may be associated with a project type 108. The project type may be implemented for display of a product or service on a specified website. For example, the project type may be implemented for display of a product or service on a specified website on a portal, such as the Microsoft™ Cloud Partner Portal™.

According to examples disclosed herein, the indication of the modification to the field 106 of the form 104 may include the indication of an addition of a new field to the form 104, or the indication of a change to an existing field of the form 104.

A schema modification module 110 may determine, in the live environment and based on the indication of the modification to the field 106 of the form 104, a modification to a schema 112. According to examples disclosed herein, the schema 112 may be a schema of the project type 108.

According to examples disclosed herein, the schema 112 may include a JSON schema.

A schema transformation module 114 may transform, in the live environment, the modification to the schema 112 to generate a transformed schema 116. The transformed schema 116 may be in a format that is usable to modify the form 104.

An input analysis module 118 may obtain, in the live environment and based on a modified form 120 generated from the transformed schema 116, an input 122 associated with the field 106.

According to examples disclosed herein, the input analysis module 118 may determine, in the live environment, whether the input 122 is valid by analyzing a validation associated with the field 106.

Based on a determination that the input 122 is invalid, the input analysis module 118 may generate an indication of invalidity associated with the field 106.

According to examples disclosed herein, based on a determination that the input 122 is valid, a modified project generation module 124 may generate a modified project 126 associated with the project type 108.

According to examples disclosed herein, the indication of the modification to the field 106 of the form 104 may include the modification to the field 106 that includes a locking field. In this regard, based on a determination that the input 122 associated with the locking field is to be locked, for example, upon publication of the modified project 126, the input analysis module 118 may generate an indication that the input 122 is not changeable, for example, upon the publication of the modified project 126.

According to examples disclosed herein, the indication of the modification to the field 106 of the form 104 may include the modification to the field 106 that is a child (e.g., mixins as disclosed herein) of another form (or another project type). In this regard, the modified project generation module 124 may modify a field of the another form (or the another project type) based on the modification to the field 106 of the modified form (or the modified project 126).

According to examples disclosed herein, the indication of the modification to the field 106 of the form 104 may include the modification to a scope of the field 106 of the form 104. In this regard, the modified project generation module 124 may duplicate the modification to the field 106 within the modified form (or the modified project 126) based on the scope.

A form generation module 128 may obtain, in a live environment, a specification 130 of a field for a new form 132. For example, the new form 132 may be associated with a new form project type 134. In this regard, the schema modification module 110 may determine, in the live environment and based on the specification 130 of the field for the new form 132, a modification to a schema. For example, the schema may be of the new form project type 134. The schema transformation module 114 may transform, in the live environment, the modification to the schema (e.g., of the new form project type 134) to generate a transformed schema. The transformed schema may be in a format that is usable to generate the new form 132. The form generation module 128 may generate, in the live environment and from the transformed schema, the new form 132. For example, the new form 132 may be for display of the product or service on the specified website.

According to examples disclosed herein, the input analysis module 118 may obtain, based on the new form 132 generated from the transformed schema, an input associated with the field for the new form 132. Based on a determination that the input is valid, a project generation module 136 may generate a project 138 associated with the new form project type 134. The new form project type 134 may be for display of a specified product or service on a specified website.

According to examples disclosed herein, the specification 130 of the field for the new form 132 may include the specification 130 for the field that includes a locking field. In this regard, based on a determination that the input associated with the locking field is to be locked upon publication, for example, of the project 138, the input analysis module 118 may generate an indication that the input is not changeable, for example, upon the publication of the project 138.

According to examples disclosed herein, the specification 130 of the field for the new form 132 may include the specification 130 for the field that is a child of another form. In this regard, the form generation module 128 may modify a field of the another form based on the field of the new form 132.

According to examples disclosed herein, the specification 130 of the field for the new form 132 may include the specification 130 for a scope of the field for the new form 132. In this regard, the form generation module 128 may duplicate the field within the new form 132 based on the scope.

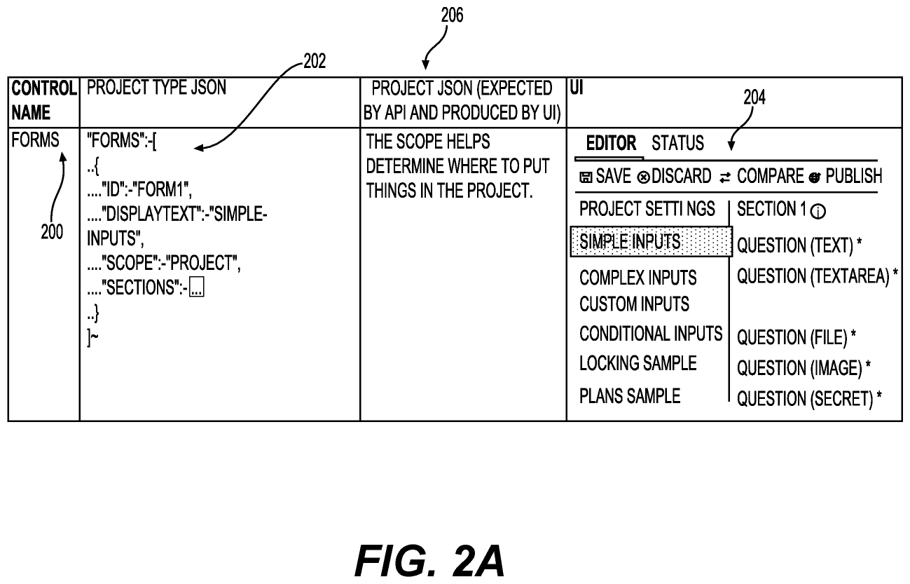

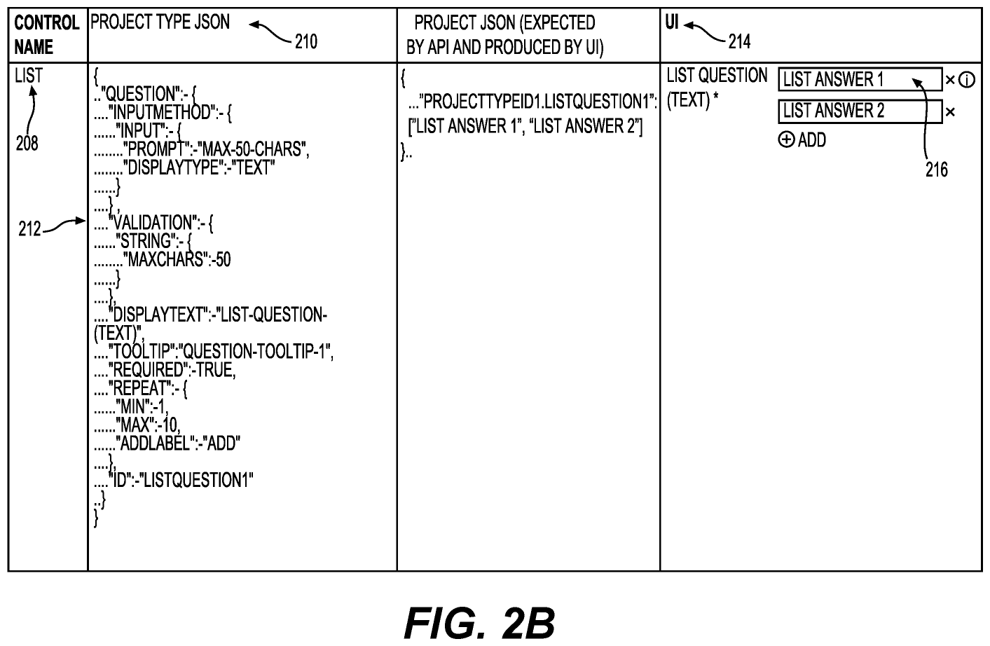

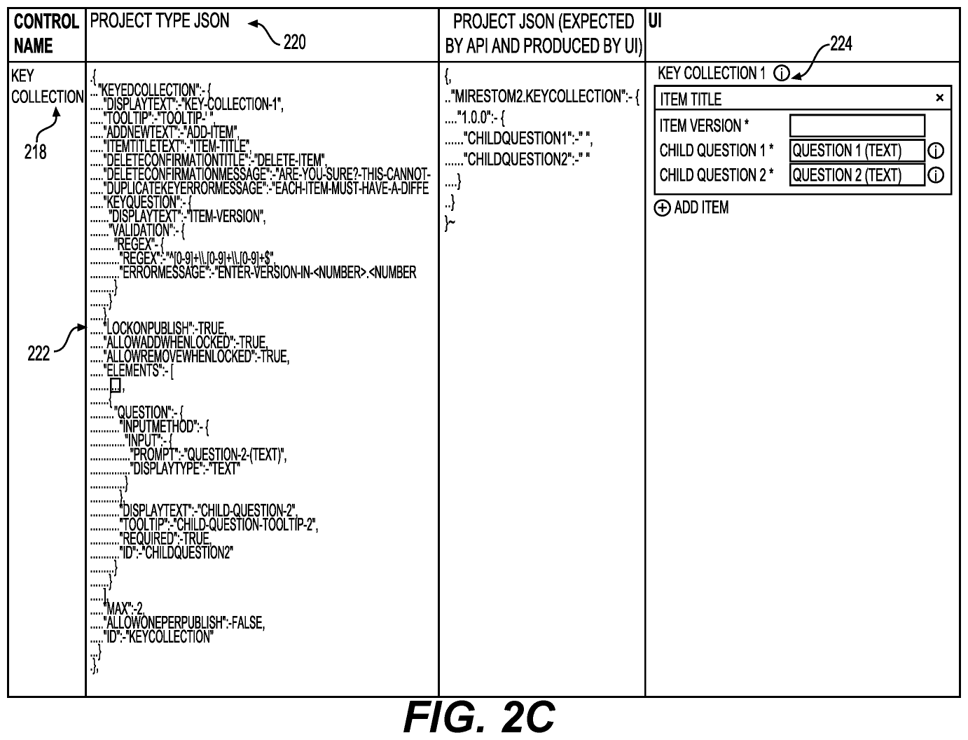

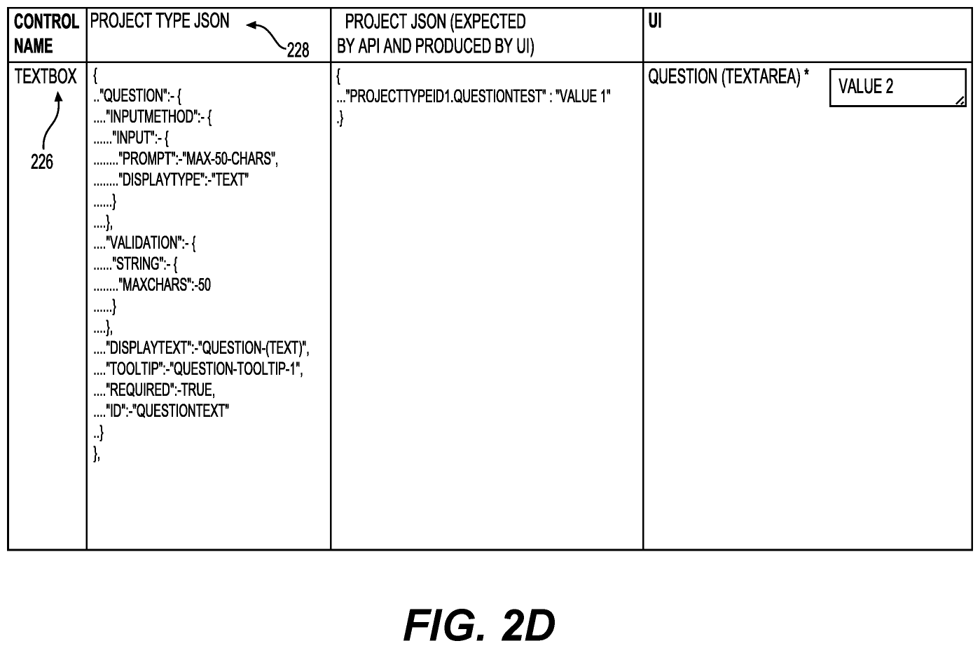

Operation of the apparatus 100 is described in further detail with reference to FIGS. 1-7F. The examples of FIGS. 2-7F illustrate operation of the apparatus 100 with respect to a project type for display of a specified product or service on a specified website. However, the examples of FIGS. 2-7F may be applied to a variety of other project types where a form may be dynamically modified and/or generated in a live environment, without having to re-deploy the environment. Examples of such project types may include manufacturing, medical, sales, etc., where a form may be dynamically modified and/or generated in a live environment, without having to re-deploy the environment.

Referring to FIG. 1, operation of the form modification module 102 and the form generation module 128 may be controlled via a JSON object. For the example of application of the apparatus 100 for a project type for display of a specified product or service on a specified website, the JSON object may be denoted a project type. For example, FIGS. 2A-2D illustrate project controls examples to illustrate operation of the apparatus 100 in accordance with an embodiment of the present disclosure. Referring to FIG. 2A, for a control name “Forms” at 200, the project type JSON is shown at 202. The control name may represent a field/value pair, where a text field may represent a control, a drop-down may represent a control, etc. The project type JSON at 202 may include entries for “id”, “displayText”, “scope”, etc., and the entries at 204 may indicate what will be shown in the form (e.g., what the user interface will reflect). With respect to the project type JSON at 202, an identification (ID) that is defined may represent a key/value pair, with the ID being the key, and the value of being what is input. The project JSON at 206 may describe the data that is saved in each of the fields, and is sent to downstream services.

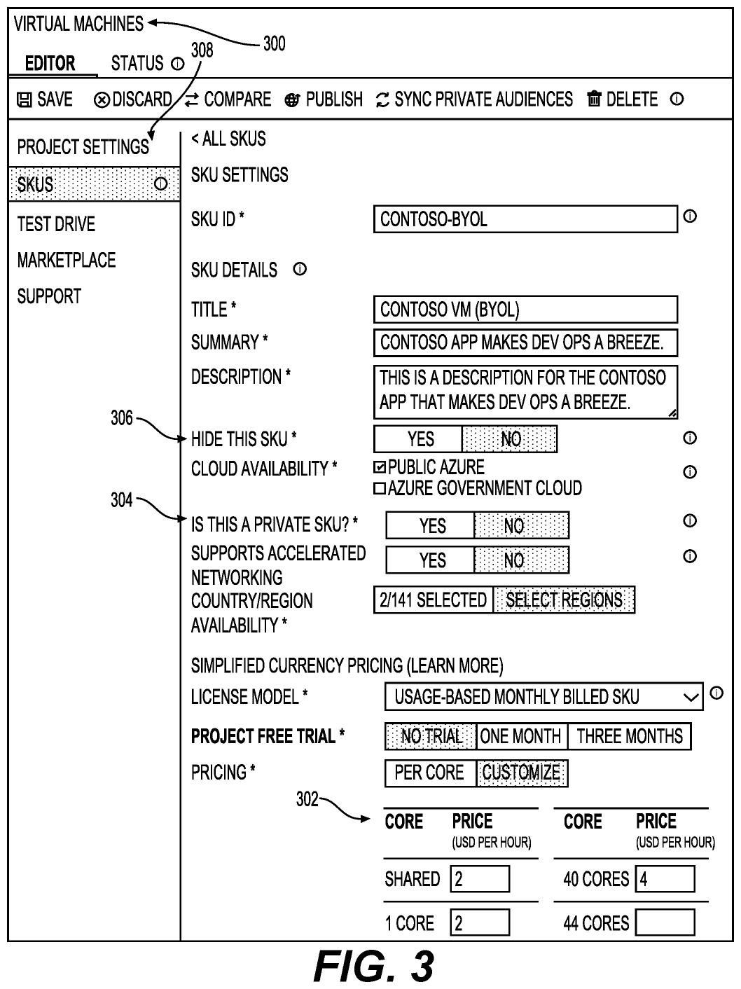

A project type may include specifications of what a JSON object for a project looks like, the user interface used to collect data for the project, validations that are performed in fields of the project (e.g., both on the client and server side), locking that is performed on properties of the project, and scoping. Examples of these aspects of a project type are disclosed herein with reference to FIGS. 3-5.

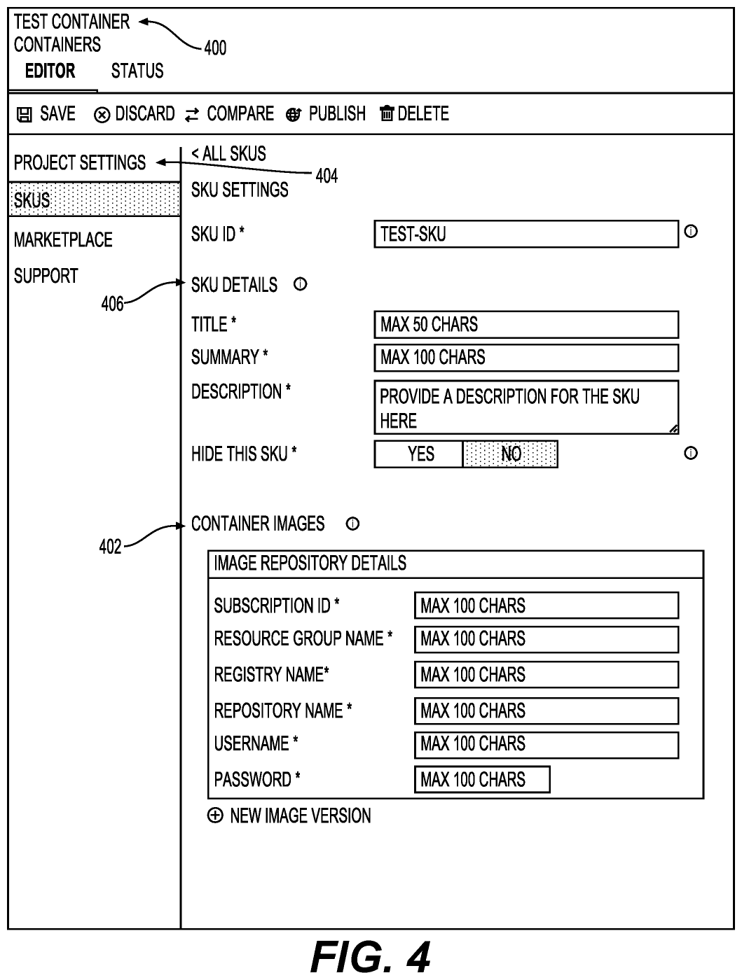

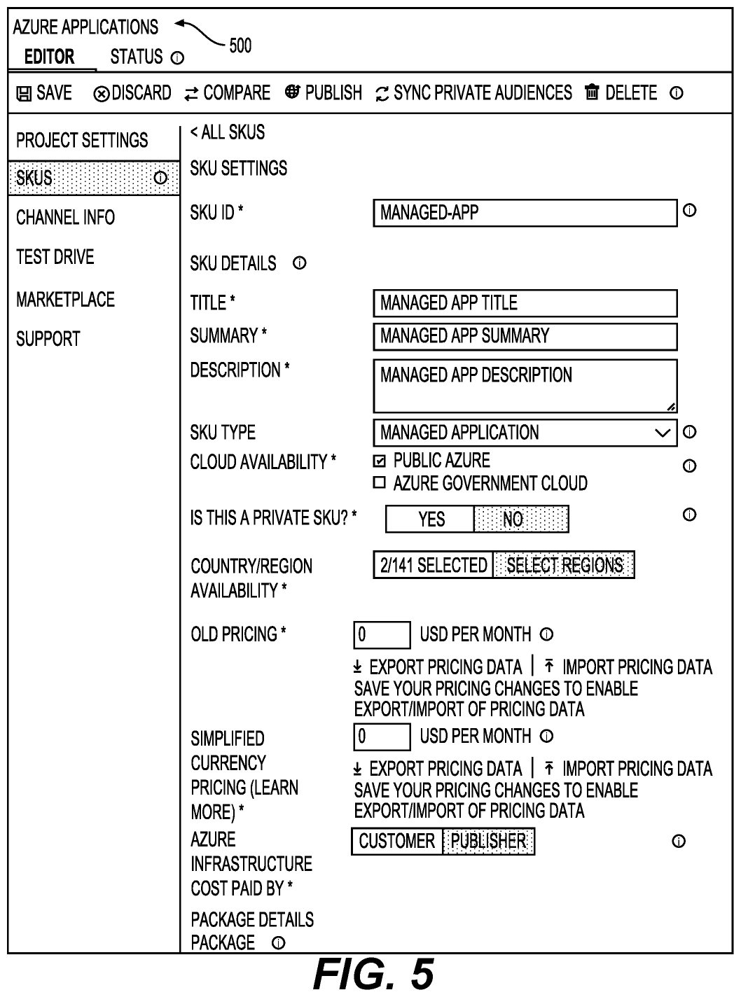

For example, FIG. 3 illustrates a virtual machines project 300 to illustrate operation of the apparatus 100 in accordance with an embodiment of the present disclosure. FIG. 4 illustrates a container project 400 to illustrate operation of the apparatus 100 in accordance with an embodiment of the present disclosure. Further, FIG. 5 illustrates an Azure™ applications project 500 to illustrate operation of the apparatus 100 in accordance with an embodiment of the present disclosure.

Referring to FIG. 3, the virtual machines project 300 may include various section headers, field names, validations, etc., where any of the fields may be added or removed by changing a project type definition. Similarly, as shown in FIGS. 4 and 5, the container project 400 and the Azure™ applications project 500 may include similar details. For example, referring to FIGS. 3 and 4, compared to virtual machines that include pricing information at 302, the container project 400 may include fields for container images at 402.

With continued reference to FIG. 3, with respect to the SKU at 304, for the field “Is this is a private SKU?”, toggling from no to yes may hide the “Supports Accelerated Networking” and “Country/Region availability” fields.

With respect to unique styles for forms as disclosed herein, features such as section headers, file names, etc., may be shown or hidden as needed.

With respect to workflows as disclosed herein, if certain fields such as “Hide this SKU” at 306 are toggled to yes, then the remainder of the form may not be hidden and may not proceed through validation. In this regard, if the field “Hide this SKU” is set to yes, downstream services may be notified to proceed to a different workflow.

With respect to specifications of what a JSON object for a project looks like, as disclosed herein, a form may be described as a list of fields (e.g., text fields, image upload fields, drop-down values, toggle fields, etc.) that define a project type. For example, the project settings at 308 may include different tabs such as “SKUs”, “Test Drive”, “Marketplace”, “Support”. Some of these tabs may represent different project type mixins. For example, referring to FIG. 4 for the container project 400, project settings at 404 may include different tabs such as “SKUs”, “Marketplace”, and “Support”, which may represent project type mixins that are shared among different project types. For example, for the mixin “Marketplace” of the virtual machines project 300 and the container project 400, the identical information that is displayed may include project title, summary, and description for each project type. Thus, whereas a project may include data, the project type (e.g., virtual machines, container, Azure™ applications, etc.) may include definitions.

With respect to validations, examples of validations may include “not the same as”, “limit values”, “cross reference rules”, “conditional info”, etc.

With respect to validations that include “not the same as”, such a validation may assert that all fields within a form set cannot have the same value.

With respect to validations that include “limit values”, such a validation may assert that a certain set of answers are not chosen when a condition is met. For example, for virtual machines, when an operating system family is “Family XYZ”, operating system type may be limited to “ABC”, “DEF”, etc.

With respect to validations that include “cross reference rules”, such rules may be defined on one field, but applied to a destination field. In this regard, the destination field may be within the same project type or a mixin that is included in the project type definition. Cross reference rules may be applied to other validations such as “not the same as”, “limit values”, “required when”, etc. The “required when” validation may specify a field value to be entered when another field value is specified. In order for the cross reference rules to be applied to two different fields, the destination field may be provided with access to the source field's value(s).

With respect to validations that include “conditional info”, this field may determine whether an element is visible based on a value of another field within a project. The “conditional info” validation may be utilized for fields that are mutually exclusive, or if a user answers a question that triggers follow-up questions that may not be needed for all users. For example, in virtual machines, a field may determine whether a project is private or not (e.g., is visible to users that are part of a specific subscription).

With respect to validations, referring to FIG. 2B, for the control name “List” at 208, under the project type JSON at 210, for the “validation” field at 212, with respect to “string”, a maximum number of characters (e.g., “maxChars”) may be specified as 50. In the user interface at 214, if an entry at 216 includes more than 50 characters, and error may be displayed indicating an invalid value.

With respect to locking (e.g., a locking field as disclosed herein) that is performed on properties of the project, referring to FIG. 2C, for the control name “Key Collections” at 218, under the project type JSON at 220, the fields at 222 including the properties “lockOnPublish”, “allowAddWhenLocked”, and “allowRemoveWhenLocked” are set to true. In this regard, a user may navigate to a blank form and input all of their values. The user may save their project (e.g., save Virtual Machine), or publish the project (e.g., publish Virtual Machine to market place). For fields that have the “lockOnPublish” set to true, when a user selects publish to market place, that field may be locked (e.g., cannot be changed). For the example of FIG. 2C, once the fields at 224 for “Key Collection 1” including “Item version”, “Child Question 1”, and “Child Question 2” are entered and published, these fields may be converted to read-only fields and may not be edited in future iterations of the project. For example, when a project is published, there may be multiple different versions of the project that may go through a workflow as the project is updated. For example, for a virtual machines project that includes a certain number of cores, if the number of cores is increased, the project may be updated and published for availability in the market place. Thus “lockOnPublish” may prevent changes to such fields.

With respect to scoping (e.g., scope as disclosed herein), certain fields may be available to a section of a project, or a SKU within a project (e.g., in the case of virtual machines). For example, referring to FIG. 2A, for the project type JSON at 202, “scope” may be at project level or SKU level. For example, a project may include multiple SKUs (e.g., versions). The scope field may define whether or not forms may be duplicated for multiple SKUs per project.

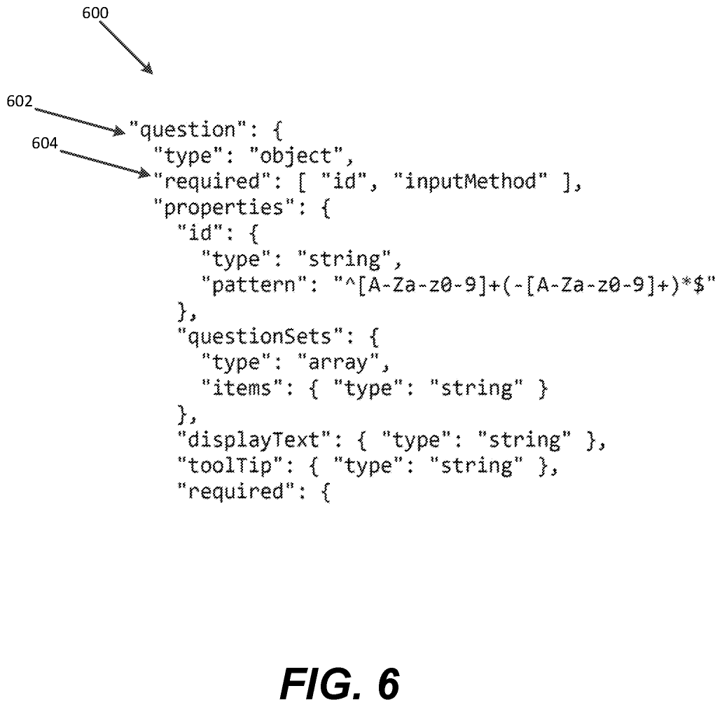

FIG. 6 illustrates a project type schema definition to illustrate operation of the apparatus 100 in accordance with an embodiment of the present disclosure.

Referring to FIG. 6, an example of a project type schema definition is illustrated at 600, and includes information that may be placed in the project type JSON (e.g., as shown in FIGS. 2A-2D). For example, with respect to “question” at 602, “required”: [“id”, “inputMethod” field] at 602, this information may be placed in the project type JSON.

Referring again to FIG. 1, as disclosed herein, the form modification module 102 and the form generation module 128 may provide for the editing and building of dynamic and complex forms on-the-fly (e.g., in a live environment). In this regard, a user, such as an administrator for a portal, may declare how the user would like to collect data for a project, which may make the project GET/PUT APIs include customizable behaviors (e.g., different validations, different object shapes, etc.) for different types of projects. For example, referring to FIG. 2D, for the control name “Textbox” at 226, under the project type JSON at 228, in order to create a new project type such as container applications as opposed to container images, a determination may be made as to a number of text fields and drop downs that are needed. For example, if the new project type utilizes three text fields and two drop downs, the form generation module 128 may be utilized to define three of the text fields in the project type JSON at 228 with different identifications, and two of the drop downs with different identifications, display tags, and options to collect data and to create the new project type.

As disclosed herein, the apparatus 100 may also provide for features such as client service validations, cross form references, and state management of user interface elements based on global states.

With respect to client service validations, if a field is input with an invalid value (e.g., a string is too long as disclosed herein with respect to the “validation” field at 212 of FIG. 2B), a text box may be highlighted to display an error.

With respect to cross form references, referring, for example, to the container project 400, with respect to the different tabs such as “Project Settings”, “SKUs”, “Marketplace”, and “Support” at 404, validations may be defined via the project type JSON. For example, with respect to the SKU details at 406, the title may define the project title with respect to SKU details, as well as the title in other sections such as “Project Settings”, “Marketplace”, etc.

With respect to state management of user interface elements based on global states, a draft state may indicate that there are changes to a field of a project that have not been saved. A save state may indicate that there are no changes to any of the fields of a project. A publish state may indicate a project has been published, which may trigger the “lockOnPublish” at 222. Thus, global states may represent the draft, saved, and published states of a project.

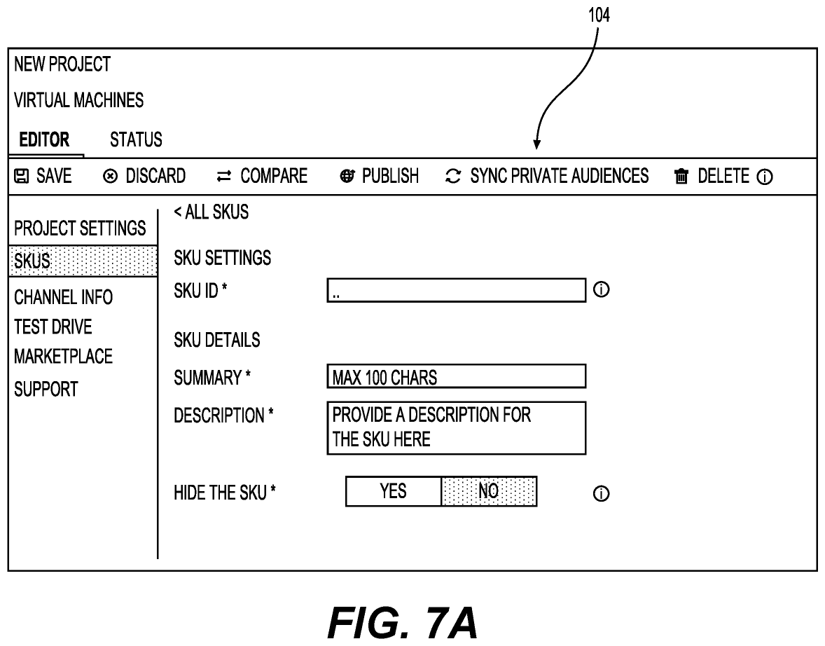

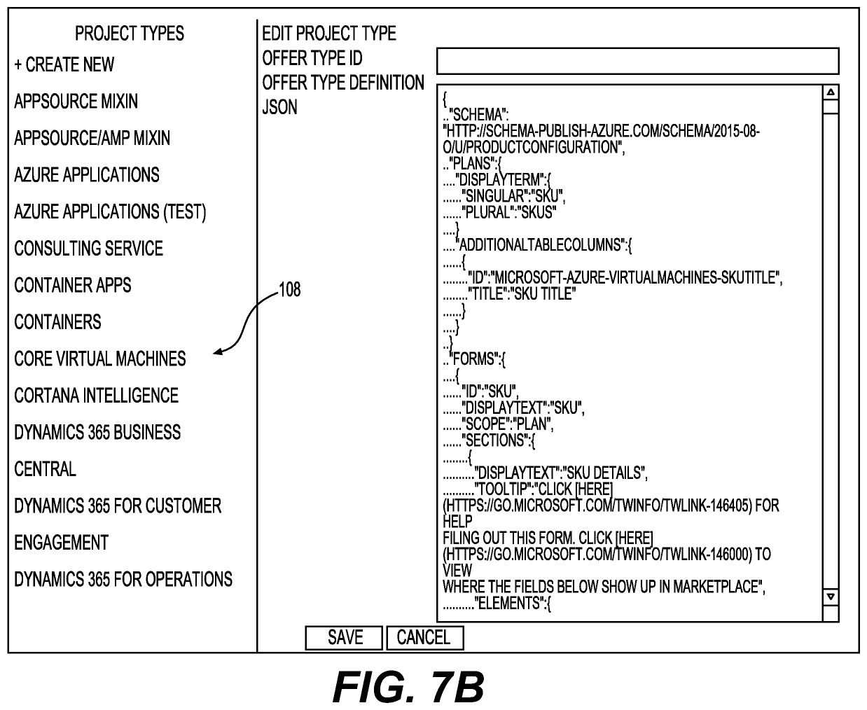

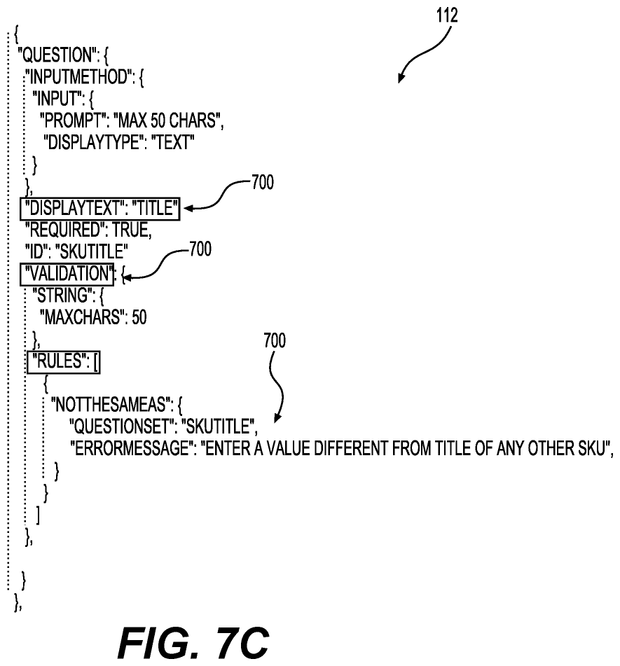

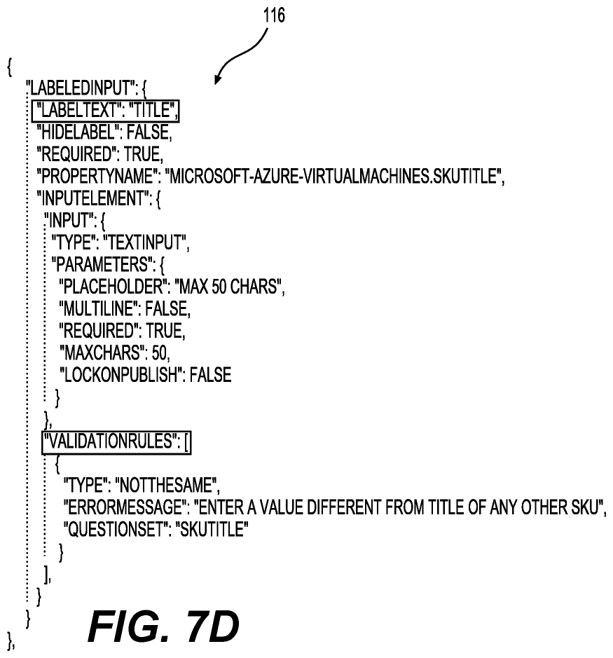

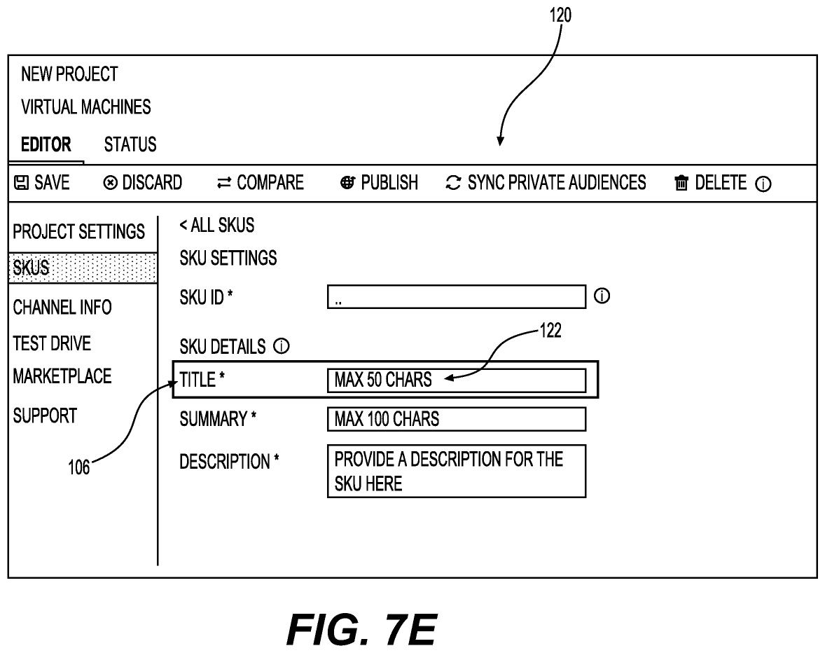

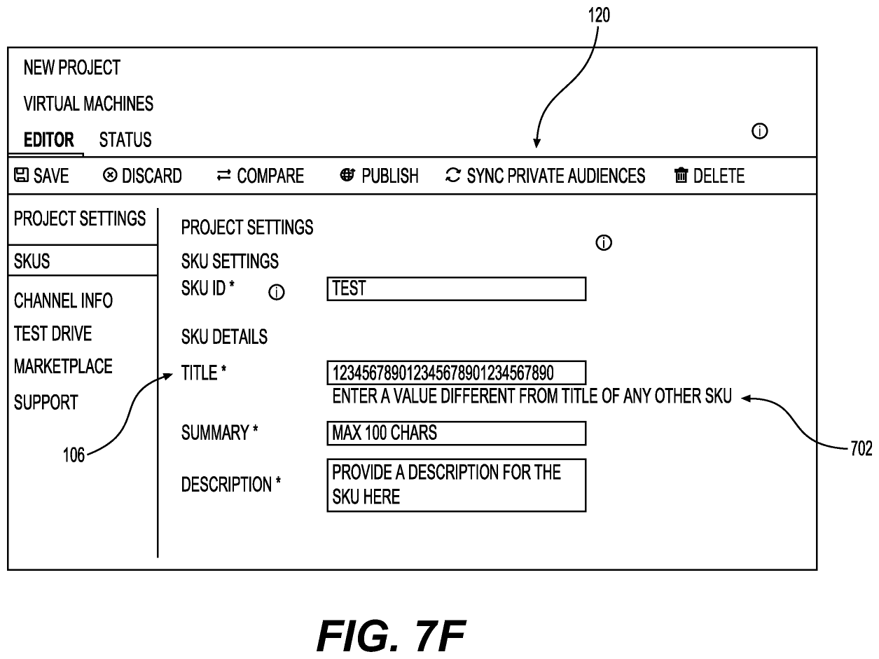

FIGS. 7A-7F illustrate various steps of a logical flow to illustrate operation of the apparatus 100 in accordance with an embodiment of the present disclosure.

Referring to FIG. 7A, the form 104 pertaining to a virtual machines project type may not include a “title” field. In this regard, the form modification module 102 may obtain an indication of a modification to a field 106 (e.g., the missing “title” field) of the form 104. For example, the indication of the modification to the field 106 of the form 104 may include an indication to include a “title” field.

Referring to FIG. 7B, a user may navigate to a portal, such as the Microsoft™ Cloud Partner Portal™, to select a pre-existing virtual machines project type 108 corresponding to the form 104 of FIG. 7A.

Referring to FIG. 7C, the schema modification module 110 may determine, based on the indication of the modification to the field 106 of the form 104, a modification to the schema 112, for example, of the project type 108. In this regard, the schema 112 may be modified at 700 to add a new text input with the display name “Title”, and with validations (e.g., validation rules) that specify that the title must be less than 50 characters long and must not be the same as any other title (e.g., “Enter a value different from title of any other SKU”).

Referring to FIG. 7D, the schema transformation module 114 may transform the modification to the schema 112, for example, of the project type 108 to generate the transformed schema 116. The transformed schema 116 may be in a format that is usable to modify the form 104.

Referring to FIG. 7E, the input analysis module 118 may obtain, based on the modified form 120 generated from the transformed schema 116, the input 122 associated with the field 106.

Referring to FIG. 7F, the input analysis module 118 may determine whether the input 122 is valid by analyzing a validation associated with the field 106. For example, as disclosed herein with respect to FIG. 7D, a validation may indicate that a title must not be the same as any other title. In this regard, assuming that an identical title is entered, based on a determination that the input 122 is invalid, the input analysis module 118 may generate an indication of invalidity associated with the field 106 (e.g., the indication at 702 may specify “Enter a value different from title of any other SKU”).

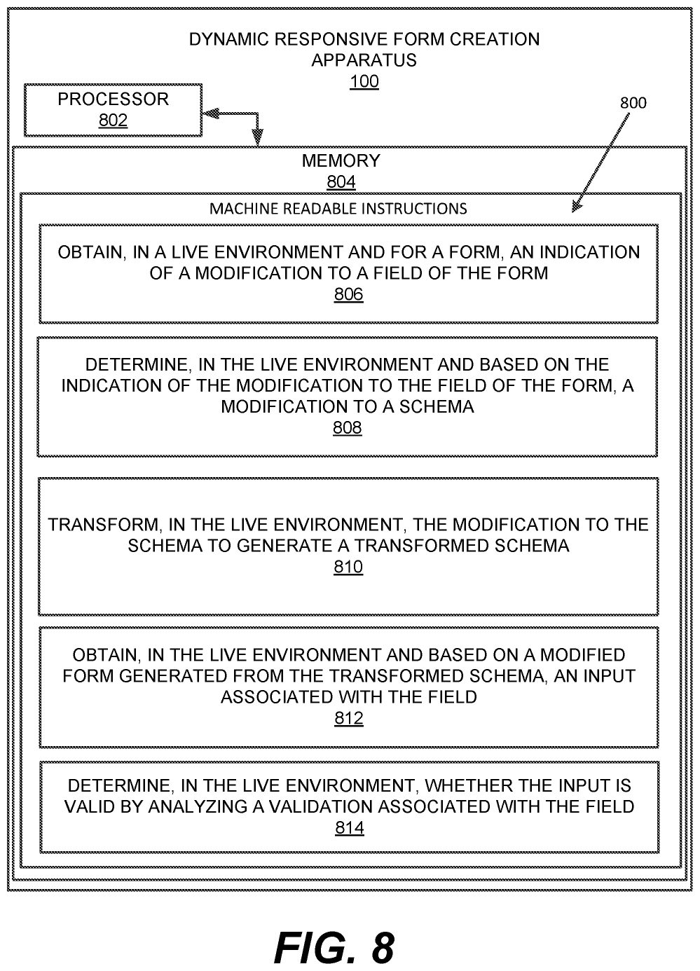

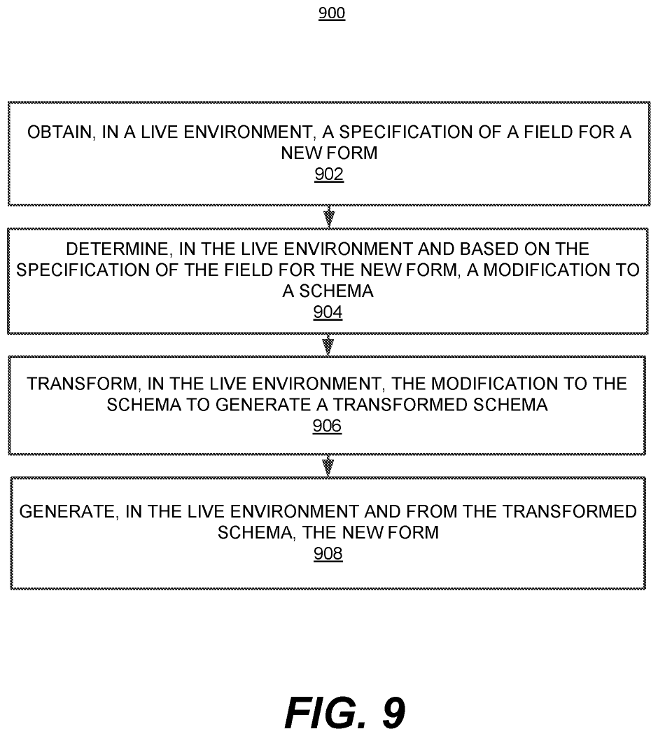

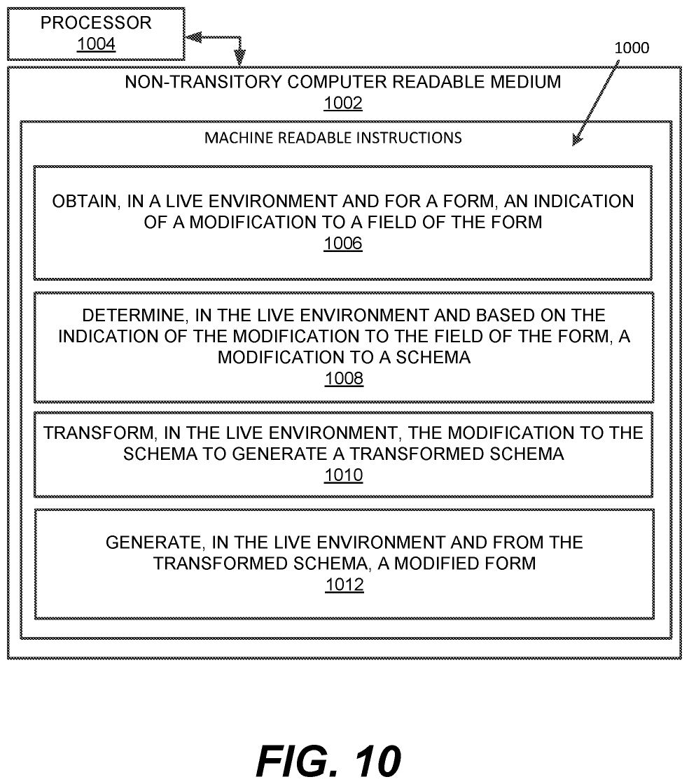

FIGS. 8-10 respectively illustrate an example block diagram 800, a flowchart of an example method 900, and a further example block diagram 1000 for dynamic responsive form creation, according to examples. The block diagram 800, the method 900, and the block diagram 1000 may be implemented on the apparatus 100 described above with reference to FIG. 1 by way of example and not of limitation. The block diagram 800, the method 900, and the block diagram 1000 may be practiced in other apparatus. In addition to showing the block diagram 800, FIG. 8 shows hardware of the apparatus 100 that may execute the instructions of the block diagram 800. The hardware may include a processor 802, and a memory 804 storing machine readable instructions that when executed by the processor cause the processor to perform the instructions of the block diagram 800. The memory 804 may represent a non-transitory computer readable medium. FIG. 9 may represent an example method for dynamic responsive form creation, and the steps of the method. FIG. 10 may represent a non-transitory computer readable medium 1002 having stored thereon machine readable instructions to provide dynamic responsive form creation according to an example. The machine readable instructions, when executed, cause a processor 1004 to perform the instructions of the block diagram 1000 also shown in FIG. 10.

The processor 802 of FIG. 8 and/or the processor 1004 of FIG. 10 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 1002 of FIG. 10), such as hardware storage devices (e.g., RAM (random access memory), ROM (read only memory), EPROM (erasable, programmable ROM), EEPROM (electrically erasable, programmable ROM), hard drives, and flash memory). The memory 804 may include a RAM, where the machine readable instructions and data for a processor may reside during runtime.

Referring to FIGS. 1-8, and particularly to the block diagram 800 shown in FIG. 8, the memory 804 may include instructions 806 to obtain, in a live environment and for a form 104, an indication of a modification to a field 106 of the form 104.

The processor 802 may fetch, decode, and execute the instructions 808 to determine, in the live environment and based on the indication of the modification to the field 106 of the form 104, a modification to a schema 112.

The processor 802 may fetch, decode, and execute the instructions 810 to transform, in the live environment, the modification to the schema 112 to generate a transformed schema 116.

The processor 802 may fetch, decode, and execute the instructions 812 to obtain, in the live environment and based on a modified form 120 generated from the transformed schema 116, an input 122 associated with the field.

The processor 802 may fetch, decode, and execute the instructions 814 to determine, in the live environment, whether the input 122 is valid by analyzing a validation associated with the field.

Referring to FIGS. 1-7F and 9, and particularly FIG. 9, for the method 900, at block 902, the method may include obtaining, in a live environment, a specification 130 of a field for a new form 132.

At block 904, the method may include determining, in the live environment and based on the specification 130 of the field for the new form 132, a modification to a schema.

At block 906, the method may include transforming, in the live environment, the modification to the schema to generate a transformed schema.

At block 908, the method may include generating, in the live environment and from the transformed schema, the new form 132.

Referring to FIGS. 1-7F and 10, and particularly FIG. 10, for the block diagram 1000, the non-transitory computer readable medium 1002 may include instructions 1006 to obtain, in a live environment and for a form 104, an indication of a modification to a field 106 of the form 104.

The processor 1004 may fetch, decode, and execute the instructions 1008 to determine, in the live environment and based on the indication of the modification to the field 106 of the form 104, a modification to a schema 112.

The processor 1004 may fetch, decode, and execute the instructions 1010 to transform, in the live environment, the modification to the schema 112 to generate a transformed schema 116.

The processor 1004 may fetch, decode, and execute the instructions 1012 to generate, in the live environment and from the transformed schema 116, a modified form 120.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

1. An apparatus comprising:
a processor; and
a computer readable medium on which is stored machine readable instructions that cause the processor to:
obtain, in a live environment and for a form, an indication of a modification to a field of the form, wherein the field includes a locking field;
determine, in the live environment and based on the indication of the modification to the field of the form, a modification to a schema;
transform, in the live environment, the modification to the schema to generate a transformed schema, wherein the transformed schema is in a format that is usable to modify the form;
obtain, in the live environment and based on a modified form generated from the transformed schema, an input associated with the field;
determine, in the live environment, whether the input is valid by analyzing a validation associated with the field; and
based on a determination that the input that is associated with the field is specified as being locked and is valid, generate an indication that the input is not changeable.

2. The apparatus according to claim 1, wherein the schema that is modified includes a JavaScript Object Notation (JSON) schema.

3. The apparatus according to claim 1, wherein the indication of the modification to the field of the form includes:
the indication of an addition of a new field to the form; or
the indication of a change to an existing field of the form.

4. The apparatus according to claim 1, wherein the instructions further cause the processor to:
based on a determination that the input is invalid, generate an indication of invalidity associated with the field.

5. (canceled)

6. The apparatus according to claim 1, wherein the indication of the modification to the field of the form includes the modification to the field that is a child of another form, and wherein the instructions further cause the processor to:
modify a field of the another form based on the modification to the field of the modified form.

7. The apparatus according to claim 1, wherein the indication of the modification to the field of the form includes the modification to a scope of the field of the form, and wherein the instructions further cause the processor to:
duplicate the modification to the field within the modified form based on the scope.

8. A computer-implemented method comprising:
obtaining, by a processor, in a live environment, a specification of a field for a new form, wherein the field includes a locking field;
determining, by the processor, in the live environment and based on the specification of the field for the new form, a modification to a schema;
transforming, by the processor, in the live environment, the modification to the schema to generate a transformed schema, wherein the transformed schema is in a format that is usable to generate the new form;
generating, by the processor, in the live environment and from the transformed schema, the new form;
obtaining, based on the new form generated from the transformed schema, an input associated with the field;
determining whether the input is valid by analyzing a validation associated with the field; and
based on a determination that the input that is associated with the field is specified as being locked upon publication of a project and is valid, generating an indication that the input is not changeable upon the publication of the project.

9. The computer-implemented method according to claim 8, wherein the schema that is modified includes a JavaScript Object Notation (JSON) schema.

10. The computer-implemented method according to claim 8, further comprising:
based on a determination that the input is valid, generating, by the processor, the project associated with a project type, wherein the project type is for display of a specified product or service on a specified website.

11. (canceled)

12. The computer-implemented method according to claim 8, further comprising:
based on a determination that the input is invalid, generating an indication of invalidity associated with the field.

13. (canceled)

14. The computer-implemented method according to claim 8, wherein the specification of the field for the new form includes the specification for the field that is a child of another form, further comprising:
modifying a field of the another form based on the field of the new form.

15. The computer-implemented method according to claim 8, wherein the specification of the field for the new form includes the specification for a scope of the field for the new form, further comprising:
duplicating the field within the new form based on the scope.

16. A non-transitory computer readable medium on which is stored machine readable instructions that when executed by a processor, cause the processor to:
obtain, in a live environment and for a form, an indication of a modification to a field of the form;
determine, in the live environment and based on the indication of the modification to the field of the form, a modification to a schema, wherein the field includes a locking field;
transform, in the live environment, the modification to the schema to generate a transformed schema, wherein the transformed schema is in a format that is usable to modify the form;
generate, in the live environment and from the transformed schema, a modified form;
obtain, based on the modified form generated from the transformed schema, an input associated with the field;
determine whether the input is valid by analyzing a validation associated with the field;
based on a determination that the input is valid, generate a modified project associated with a project type, wherein the project type is for display of a specified product or service on a specified website; and
based on a determination that the input that is associated with the field is specified as being locked upon publication of the modified project and is valid, generate an indication that the input is not changeable upon the publication of the modified project.

17. (canceled)

18. (canceled)

19. The non-transitory computer readable medium according to claim 16, wherein the indication of the modification to the field of the form includes the modification to the field that is a child of another form, and wherein the instructions further cause the processor to:
modify a field of the another form based on the modification to the field of the modified form.

20. The non-transitory computer readable medium according to claim 16, wherein the indication of the modification to the field of the form includes the modification to a scope of the field of the form, and wherein the instructions further cause the processor to:
duplicate the modification to the field within the modified form based on the scope.

21. (canceled)

22. The apparatus according to claim 1, wherein the instructions to determine, in the live environment, whether the input is valid by analyzing the validation associated with the field further cause the processor to:
determine, in the live environment, whether the input is valid by analyzing the validation that includes an analysis of whether all fields in the form include same or different inputs as the input.

23. The apparatus according to claim 1, wherein the instructions to determine, in the live environment, whether the input is valid by analyzing the validation associated with the field further cause the processor to:
determine, in the live environment, whether the input is valid by analyzing the validation that includes a limit value validation that specifies a field that is not selectable when a condition is met.

24. The apparatus according to claim 1, wherein the instructions to determine, in the live environment, whether the input is valid by analyzing the validation associated with the field further cause the processor to:
determine, in the live environment, whether the input is valid by analyzing the validation that includes a conditional validation that specifies a field that is not visible when a condition associated with another field is met.

25. The apparatus according to claim 1, wherein the instructions to determine, in the live environment, whether the input is valid by analyzing the validation associated with the field further cause the processor to:
determine, in the live environment, whether the input is valid by analyzing the validation that includes an analysis of a cross reference rule that is defined on one field and applied to another field.

26. The apparatus according to claim 1, wherein the instructions to determine, in the live environment, whether the input is valid by analyzing the validation associated with the field further cause the processor to:
determine, in the live environment, whether the input is valid by analyzing the validation that includes an analysis of whether the input is a duplicate of a corresponding input of a corresponding field of another form.
